(19) United States
(12) Patent Application Publication
(10) Pub. No.: US 2010/0288001 A1
(43) Pub. Date: Nov. 18, 2010

(54) Security Cryptographic Device

(76) Inventor: Pedro Jose Iglesias Rosado, Seville (ES)

Correspondence Address: JOHN ALEXANDER GALBREATH, 2516 CHESTNUT WOODS CT, REISTERSTOWN, MD, 21136, US

(21) Appl. No.: 12/863,484

(22) PCT Filed: Jan. 19, 2009
(86) PCT No.: PCT/ES2009/000025

§ 371 Date: Jul. 19, 2010

(30) Foreign Application Priority Data
Jan. 21, 2008 (ES) P200800227

(51) Int. Cl. E05B 37/20

(52) U.S. Cl. 70/289

(57) ABSTRACT

Security cryptographic device comprising a device essentially characterized by the mechanism of bolts (7 and 7a), with different features, thereof and at least one tool for operating the bolts (3). Depending on the features of the bolts (7 y 7a), the latter can operate in one or several directions and/or in one or both directions and can lock automatically and/or on being operated and be operated individually or together. Depending on the features of the device, not all the tools for operating bolts (3) have to match all the bolts (7 and 7a), nor do all the bolts (7 and 7a) have to match all the cavities (5), which means having to know which bolt (7 and 7a) matches each cavity (5), which tool (3) matches each bolt (7 and 7a), and whether or not each bolt (7 and 7a) should be operated.

### FIELD OF THE TECHNIQUE

the invention falls within the technical fields of mechanical puzzles, logic games, locks, padlocks, safety deposit boxes, strongboxes and cryptography.

### STATE OF THE TECHNIQUE

Nowadays there are a number of cryptographic devices and security systems such as locks, padlocks, safety deposit boxes, strongboxes and the cylindrical cryptographic device called Cryptex. The invention of Cryptex is ascribed by Dan Brown to Leonardo Da Vinci in his “The Da Vinci Code” describing it as “ . . . a portable container that can contain any type of document with information written on fine papyrus, which can only be accessed by a person who knows the password.” In order to do it, you must place five discs in the correct sequence, each of which contains 26 letters, thus the internal gears being aligned and the cylinder being opened. If the cryptex is forced, a delicate glass tube containing vinegar breaks. The papyrus is rolled up around this tube so vinegar dissolves quickly on it . . . ”

A new device has been devised. Its characteristics, that improve the backgrounds significantly, are the subject of the present invention focusing on its mechanism.

### DETAILED DESCRIPTION OF THE INVENTION

The present invention is related to a Cryptographic Security Device of the type of those requiring combinations based on codes for their opening.

The new device is essentially characterized by its latch mechanism with different characteristics and at least one instrument to activate latches. This mechanism, thanks to its simplicity and minimum space requirements, is operative in minimum spaces and is not limited by its form or number, orientation or direction of latch closing or the number of compartments to which they give access. It also allows to increase considerably the number of possible combinations in a minimum space and allows its use with alphabets and/or writing systems consisting of such an elevated number of characters that make it unworkable in other devices mentioned in the state of the technique.

Latches, depending on their characteristics, may act in one or more directions and/or in one or more ways and can block automatically and/or when they are activated and also can be activated individually or jointly. Depending on the characteristics of the device not all instruments used to activate latches have to match with all the latches, nor all the latches with all the cavities, which demands to know what latch matches with each cavity, and which instrument matches with each latch and if each of them must be activated or not.

### DESCRIPTION OF THE DRAWINGS

For a better understanding of what is described in the present report we attach drawings in which, by way of example, a practical case of operation of the cryptographic security device is represented.

In such drawings FIG. 1 is a view of a spherical device;

FIG. 2 is a view of both parts, separated, of a double spherical device with mobile groups of instruments to activate latches that can be moved horizontally and vertically;

FIG. 3 is a longitudinal section view of a spherical device with the cartridge removed;

FIG. 4 is a longitudinal section view of a latch that blocks, in rest, in one sole direction, and unblocks when activated in the only possible direction;

FIG. 5 is the same view of the latch of FIG. 4, but once activated;

FIG. 6 is a longitudinal section view of a latch that blocks, while in rest position, in both directions. It can be operated in one or both ways simultaneously and be unblocked correlatively;

FIG. 7 is the same view of the latch of FIG. 6, but once activated;

FIG. 8 is a longitudinal section view of a latch that blocks, while in rest position, in both directions. It can be operated in both ways, not simultaneously, and can be unblocked correlatively in one way or another but not in both;

FIG. 9 shows the same view of the latch of FIG. 8, but once activated;

FIG. 10 is a longitudinal section view of a latch than, at rest, blocks in one direction and when activated unblocks, but blocks correlatively in the opposite direction;

FIG. 11 is the same view of the latch of FIG. 10 once activated;

FIG. 12 is a longitudinal section view of a latch that, at rest, blocks in both directions. It can be activated in one or both directions simultaneously and can be unblocked correlatively, but when you unblock one way it blocks in the opposite way;

FIG. 13 is the same view of the latch of FIG. 12 once activated;

FIG. 14 is a longitudinal section view of a latch that does not block at rest, and blocks when being activated in the only possible way;

FIG. 15 is the same view of the latch of FIG. 14 once activated with a tool to activate latches that blocks in the opposite direction that it activates;

FIG. 16 is the same view of the latch of FIG. 14 once activated with a tool to activate latches that does not block in the opposite way that it activates;

FIG. 17 is a longitudinal section view of a latch that does not block at rest. It can be operated in one or both ways simultaneously and can block correlatively;

FIG. 18 is the same view of the latch of FIG. 17 once activated;

FIG. 19 is a longitudinal section view of a latch that does not block at rest. It can be activated and blocked in one way or the other but not in both ways;

FIG. 20 is the same view of the latch of FIG. 19 once activated;

FIG. 21 is a longitudinal section view of a latch that blocks, at rest, in one sole way. It can be activated in one or both ways simultaneously, it unblocks in one way and blocks in the other;

FIG. 22 shows the same view of the latch of FIG. 21 once activated;

FIG. 23 is a longitudinal section view of a latch at rest that blocks in both ways. It can be activated in one or both directions simultaneously, it correlatively unblocks in one way and blocks in the opposite way, and in the other way it just unblocks;

FIG. 24 is the same view of the latch of FIG. 23 once activated;

FIG. 25 is a longitudinal section view of a latch that does not block at rest. It can be activated in several directions and ways correspondingly blocking in the remaining directions and ways;

FIG. 26 is the latch of FIG. 25 once activated;

FIG. 27 is a spherical device with mobile groups of instruments to activate latches that can be moved horizontally, vertically and diagonally;

FIG. 28 is an elevation view of an instrument to activate a combination of latches simultaneously;

FIG. 29 is a profile view of an instrument to activate a combination of latches simultaneously.

### EXAMPLE OF CREATION

The cryptographic security device comprises an artifact with changeable shapes (spherical, conical, pyramidal, etc.) and dimensions whose pieces can be made of different materials (plastic, wood, metal, etc.) depending on costs and the purpose thereof and on the device itself. The use of metal parts on them or the application of a metal layer over them, in addition to avoiding the possible visibility inside the device, would prevent from getting to know the content and/or deduce the combination to access it using techniques such as X-rays.

The invention is additionally illustrated by the following example which does not intend to limit its scope.

Cryptographic security device comprised of a sphere (FIG. 1) that has a surface area of two exchangeable rotating rings (1), mounted on riding gears (2) allowing rotation to the desired position, and 360 instruments to activate latches (3) that, when leaving their resting state, strike retractable rods (4) contained in as many cavities (5) with springs (6) that drill them. Rods (4) strike, in turn, on a system of latches (7 and 7a) when these instruments used to activate latches (3) also leave their resting state. It also contains an interchangeable cartridge (8) cylindrical section of the sphere that passes through its vertical axis.

Each of the latches (7 and 7a), depending on their characteristics, may act in one or more directions and/or in one or more ways and can block automatically and/or when activated and be activated individually or jointly.

The tools used to activate latches (3) or groups of instruments used to activate latches (3a) may be contained in moving parts (9) mounted on slots. In this case the part of the instruments used to activate latches (3) which strikes on the rods (4), the rods themselves (4) and cavities (5) that contains them, the cavities of cartridges (8), those of the containers (10) and the latches (7 and 7a) can be of different sizes and/or shapes (squared, triangular, circular, etc.). Each moving part (9) should be moved to the right place so that the tools that activate latches (3), rods (4), cavities (5) and latches (7 and 7a) coincide in size and/or shape.

The number and type of instruments used to activate latches (3), rods (4), cavities (5), latches (7 and 7a), compartments (11), cartridges (8) and containers (10) may vary depending on the needs and the type of mechanism of the device (mechanical, magnetic, hydraulic, electrical, electronic, etc.).

The frame of the cartridge (8), a tubular section of the same, open at both ends and divided into two perpendicularly to the vertical axis, is perforated by 360 holes (5) that coincide with those of the sphere. This frame contains two containers (10), intended in turn to contain something, that strikes on springs (12) of which the cartridge frame disposes (8) and that put pressure on the containers (10) forcing its departure from the same, containers (10) which are comprised by two united pieces, namely:
an inner part (13), tubular section of the cartridge (8), compact and open at the end that is situated inside of it. This piece can contain a blister (14) fragile tubular with fluid inside that would be broken if pressure was applied to it.

If the device allows for its partial self-destruction and/or of the contents within the containers (10), the mentioned device, except for the part to be destroyed and/or of the contents of the containers (10), shall be made of a resistant material to the action of the fluid contained inside the blisters (14) which are in turn contained in it. These fluids will be adequate to destroy that mentioned part of the device and/or the contents of each container (10):—

An outer part (13a), the tubular section of the cartridge (8) opened by the end that is inside of it, pierced by 108 cavities (5) of a container (10) and by 144 of the other. They coincide with the ones on the top of the cartridge frame (8) in the first container and the central part in the second.

For each of the cavities (5) of the outer part of the containers (13a), which contain springs (6), a latch can appear (7), whose projections (15) are adapted to spaces (16) in those cavities (5) intended for the purpose, a latch that is inserted into it when it is struck. Such latch (7) is inserted into the cavity (5) matching the cartridge frame (8) unless it has not been struck, blocking the container (10) and preventing the spring (12) on which it strikes to eject such container out of the cartridge frame (8).

The cavities (5) of the cartridge frame (8) that will receive the latches (7) of the outer part of the containers (13a) are initially empty, while those that are not going to receive any, contain a spring (6) and a latch (7) whose projections (15) are adapted to some spaces (16) in the mentioned cavities (5) for the purpose.

When tools are pressed to activate adequate latches (3), by making them abandon their resting state, these strike on rods (4) which in turn impact on the latches (7) of the outer part of the containers (13a) introduced in the cavities (5) of the cartridge frame (8), taking them out of the same and releasing the containers (10).

When tools are pressed to activate inadequate latches (3), causing them to abandon their resting state, these fall on rods (4) which in turn strike on the latches (7) contained in the cavities (5) of the cartridge frame (8) introducing them into the cavities of the outer part of the containers (13a) and blocking them.

When all the instruments used to activate adequate latches (3), and only them, of each group of instruments used to activate latches (3a) that activate the latches (7) operating over one container, (10) have abandoned its resting state, the mentioned container (10) is released allowing the spring (12) on which it strikes to eject it from the cartridge frame (8).

The 108 cavities (5) of the cartridge frame (8) that do not match those of the outer part of the containers (13a), as happens with these, contain springs (6). For each of the cavities a latch may show (7), whose projections (15) are adapted to spaces (16) in the mentioned cavities (5) intended for the purpose. The mentioned latch is inserted into the cavity when striking on it. The cavities (5) on which these latches do not show (7) contain in this case a loose latch (7a) without projections (15). Both groups initially remain within the cavities, (5) secured by a seal (17).

The cartridge frame (8) has on its outer face a few projections (18) which cross it longitudinally and partially and that fit in as many slots (19) that the sphere contains inside. The slots (19) lead it when it is inserted until the moment when, having reached some limits, (20) the seal (17) is displaced thereby releasing the latches (7 and 7a) which are inserted into the matching cavities (5) in the sphere, blocking it and preventing the spring (21), on which it falls, which in turn puts pressure on it forcing his way out of the sphere, from ejecting it from the same, thus remaining installed in the right place.

When tools are pressed (3) in order to activate adequate latches, making them abandon its resting state, these strike on rods (4) which in turn strike on the latches (7) of the frame of the cartridge inserted in the cavities (5) matching with the sphere and taking them out of the same and releasing the cartridge frame (8).

When tools are pressed in order to activate inadequate latches (3), causing them to abandon their resting state, they fall on rods (4) which in turn strike on the loose latches (7a) that were introduced in the cavities (5) of the sphere, introducing them into the cavities (5) matching the cartridge frame (8), blocking it.

When all the instruments used to activate adequate latches (3), and only them, of each group of instruments used to activate latches (3a) that activate latches (7 and 7a) that act on the cartridge frame (8) have left their resting state, the cartridge frame (8) is released allowing the spring (21) on which it strikes to eject it out of the sphere.

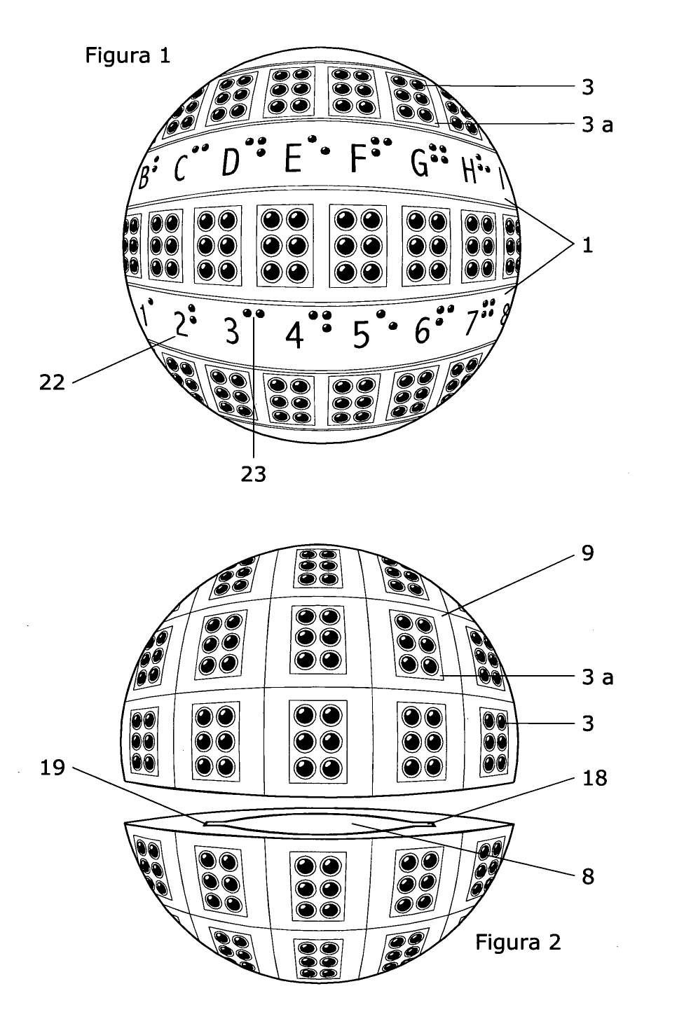

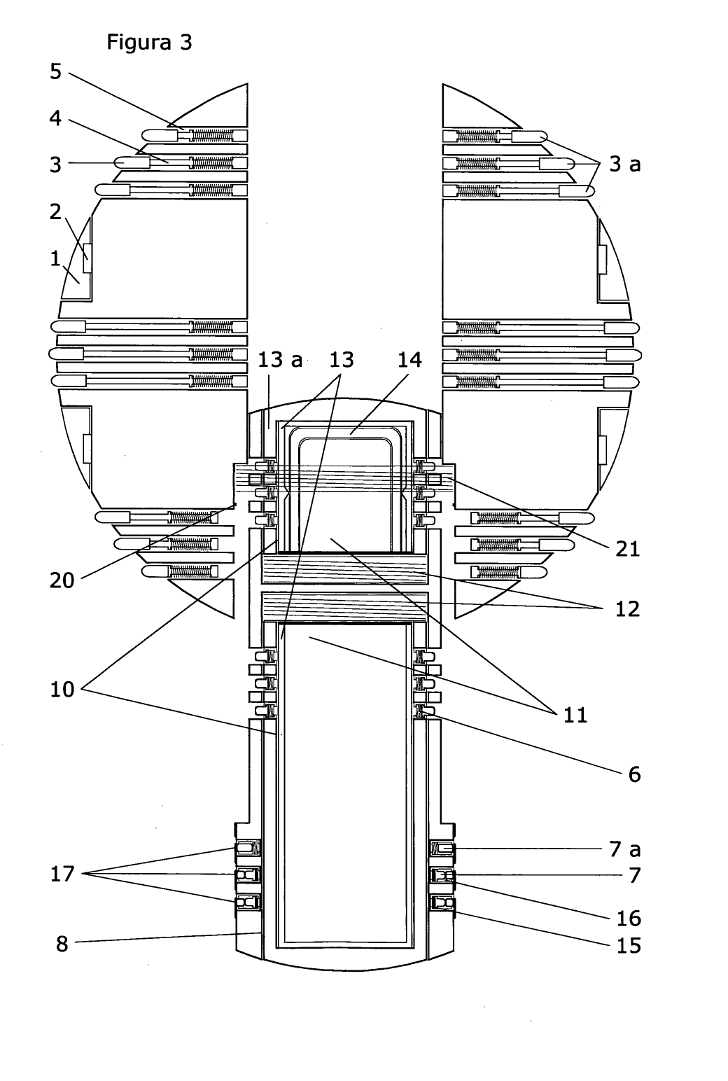

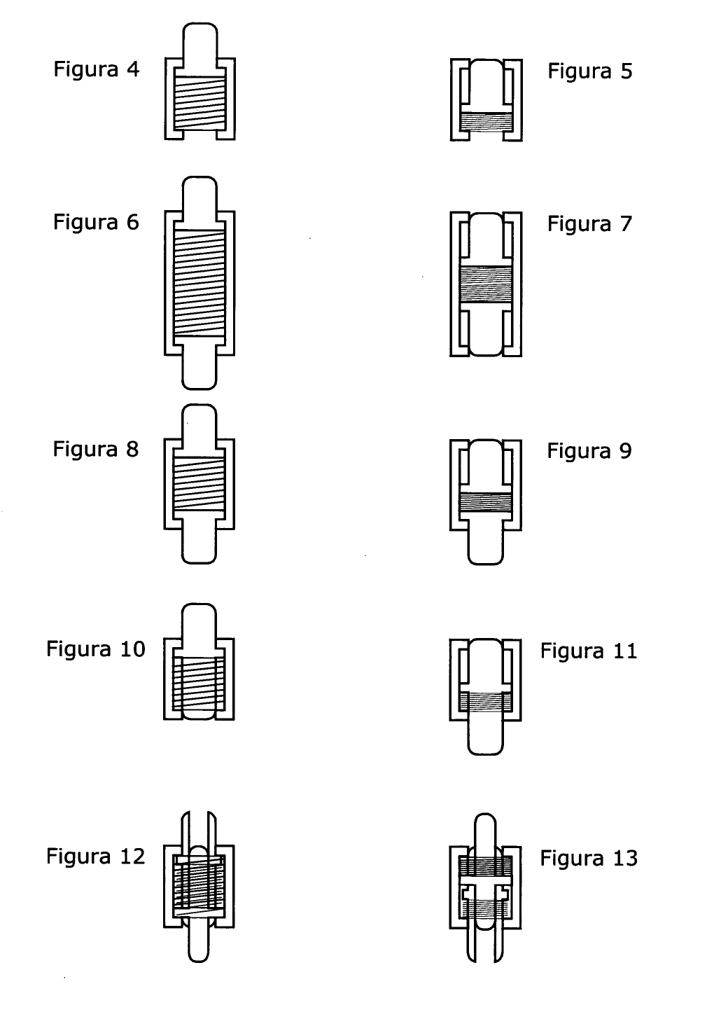

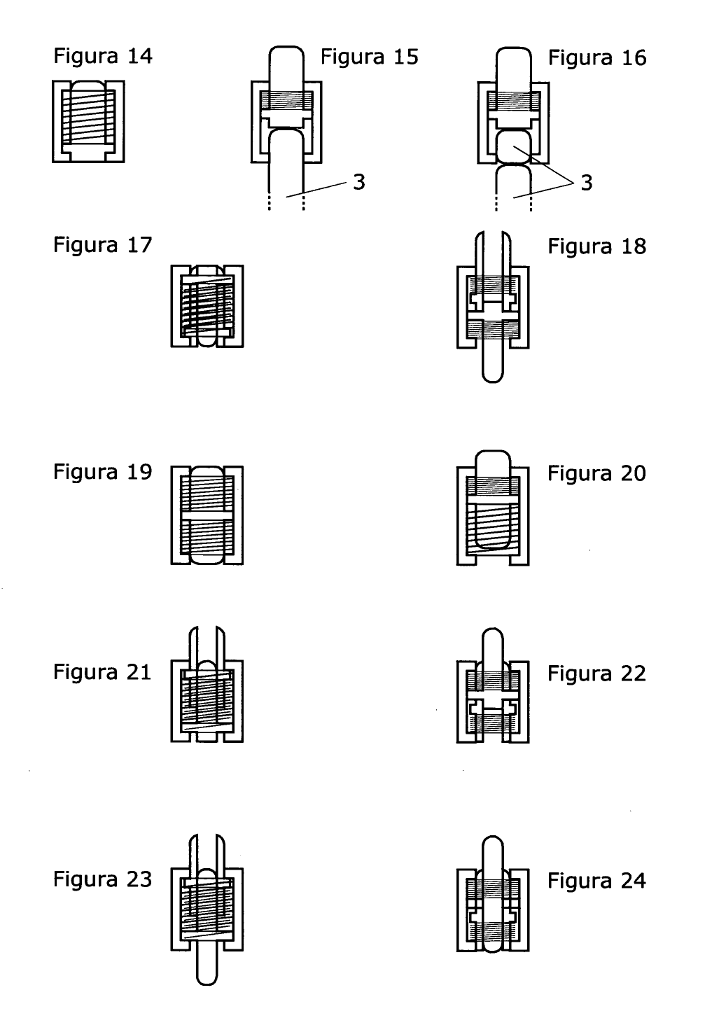

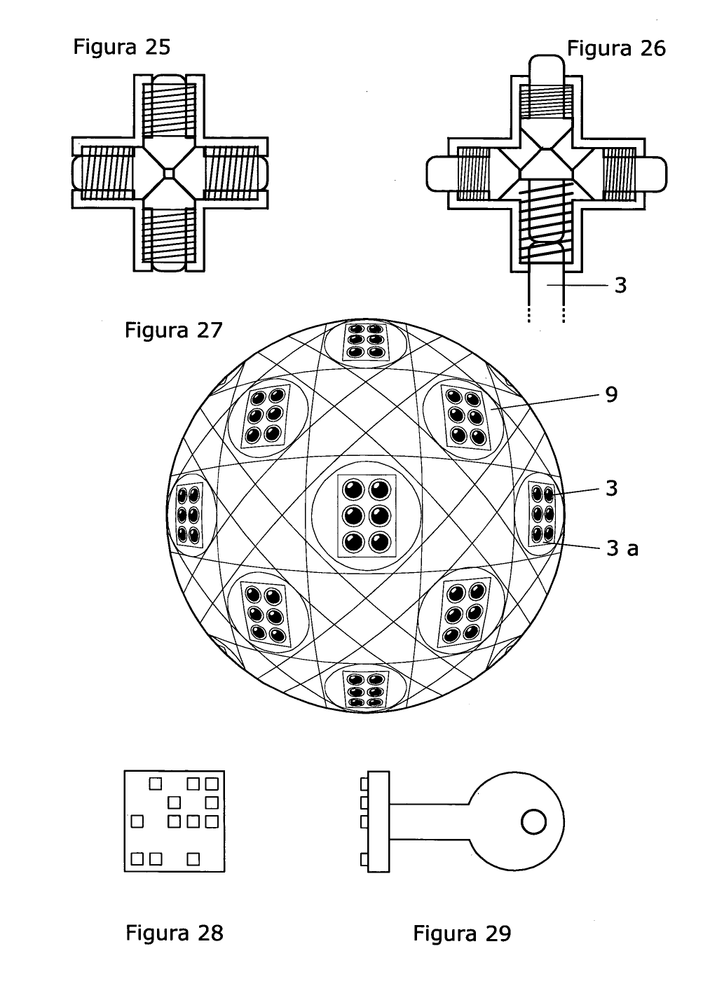

In some cases the same device may be comprised of several devices (FIG. 2) joined by latches (7) with different characteristics. In these cases some of the moving parts (9) have a component of different characteristics in each of them that adapts only to one of the latches (7) connecting the devices (FIG. 2), allowing it to have a strike on it and take it out of the cavity (5) that hosts it. When all the mentioned pieces (9) have been located in the right place and its components have taken the latches (7) that linked the devices (FIG. 2) out of the cavities (5) that housed them, these can be separated.

Both on the surface of the device (FIG. 1) and in some of its parts, or in the two interchangeable rotating rings (1) in the surface of the sphere, depending on the characteristics and the purpose thereof, letters, numbers, images and symbols of all kinds can be shown printed or inscribed (22), and also their correspondence with combinations (23) applicable to the device (FIG. 1).

In order to facilitate the installation of the device (FIGS. 1, 2 and 27) the matching cavities (5) of its several parts can be named with the same graphic characters, printed or inscribed.

1. Cryptographic security device comprising a plurality of cavities (5) drilling a plurality of bodies, a plurality of latches (7 and 7a) to block bodies, some of which have different characteristics and some instrument to activate the latches (3) characterized by the fact that, according to their characteristics, the latches (7 and 7a) may act in one or more directions and can automatically block when activated,
characterized by the fact that each of the latches on the basis of their features:
blocks in one direction while at rest state, and when it is activated in the only possible direction, it unlocks (FIG. 4).
While at rest, it blocks in both directions. It can be operated in one or both directions simultaneously and sequentially unblock (FIG. 6).
while at rest, it blocks in both directions. It can be activated in both directions not simultaneously and sequentially unblock in one way or another but not in both (FIG. 8).
While at rest, it blocks in one direction and once activated it unblocks, but consecutively blocks in the opposite direction (FIG. 10).
while at rest, it blocks in both directions. It can be activated in one or both directions simultaneously and sequentially unblock, but as it unblocks in one way it blocks in the opposite direction (FIG. 12).
In resting state, it does not block, and, being activated in the only possible direction, it blocks (FIG. 14)
While at rest, it does not block. It can be activated in one or both directions simultaneously and block sequentially (FIG. 17).
While at rest, it does not block. It can be activated and locked in one way or another but not in both (FIG. 19).
at rest, it blocks in one direction. It can be operated in one or both directions simultaneously, it unlocks in one direction and blocks in the other (FIG. 21).
while at rest, it blocks in both directions. It can be activated in one or both directions simultaneously, in one it unblocks and blocks sequentially in the opposite direction and in the other direction it only unblocks (FIG. 23).
In which that latches of the type of those that act in one or more directions (FIG. 25) when activated in any of the directions may, depending on their characteristics, block sequentially in one of the other directions (FIG. 26), and in which
not all instruments used to activate latches (3) need to match all the latches (7 and 7a),
neither not all latches (7 and 7a) have to match with all the cavities (5).
Characterized besides by the fact that instruments used to activate latches (3) may include moving parts (9) capable of being displaced in different directions.
In which that instruments used to activate latches (3), according to their characteristics may:
Block in the opposite direction to that direction used when it activates (FIG. 15).
No block in the opposite direction to the direction used when it activates (FIG. 16).
And in which that instruments used to activate latches (3) according to their characteristics may:
activate latches individually (3).
jointly activate latches (FIGS. 28 and 29).

2. (canceled)

3. (canceled)

4. (canceled)

5. (canceled)

6. (canceled)

7. (canceled)

8. (canceled)
